(19) United States
(12) Patent Application Publication
(10) Pub. No.: US 2025/0214375 A1
(43) Pub. Date: Jul. 3, 2025

(54) TIRE

(71) Applicant: SUMITOMO RUBBER INDUSTRIES, LTD., Kobe-shi (JP)

(72) Inventor: Ryo YAJIMA, Kobe-shi (JP)

(73) Assignee: SUMITOMO RUBBER INDUSTRIES, LTD., Kobe-shi (JP)

(21) Appl. No.: 18/965,233

(22) Filed: Dec. 2, 2024

(30) Foreign Application Priority Data
Dec. 27, 2023 (JP) 2023-221515

(51) Int. Cl. B60C 5/14; B60C 1/00

(52) U.S. Cl. CPC B60C 5/14; B60C 1/0008; B60C 2005/145

(57) ABSTRACT

Provided is a tire comprising an inner liner and an insulation touching the inner liner on an outer side of the inner liner in a tire radial direction, wherein the insulation is composed of a rubber composition comprising a recovered carbon black, wherein an air permeation coefficient of a rubber composition constituting the inner liner is less than 18×10⁻¹¹ cm³·cm/(cm²·s·cmHg), wherein a thickness of the inner liner on a tire equatorial plane is 1.5 mm or less, and wherein a loss tangent at 70° C., 70° C. tan δ, of a complex of the insulation and the inner liner is 0.22 or less.

### CROSS-REFERENCE TO RELATED APPLICATION

This application claims priority to JP Application No. 2023-221515, filed Dec. 27, 2023, the disclosure of which is expressly incorporated herein by reference in its entirety.

### TECHNICAL FIELD

The present invention relates to a tire.

### BACKGROUND OF THE INVENTION

An inner cavity surface of a tire is provided with an inner liner as an air permeation-suppressing layer for retaining air pressure of the tire. Recently, a demand for fuel efficiency of a car has been increasing, and inner liners have also been improved for that reason (JP 2018-165087 A). Achievement of fuel efficiency by thinning an inner liner and improving air permeation suppressibility has been considered, but on the other hand, for an inner liner and an insulation adjacent to the inner liner (which is also referred to as a “tie gum layer”), there is also a problem such as a warp or an exfoliation on their interface, and thus a further improvement has been demanded.

### SUMMARY OF THE INVENTION

It is an object of the present invention to provide a tire having improved tire air permeation-suppressing performance.

The present invention relates to a tire comprising an inner liner and an insulation touching the inner liner on an outer side of the inner liner in a tire radial direction, wherein the insulation is composed of a rubber composition comprising a recovered carbon black, wherein an air permeation coefficient of a rubber composition constituting the inner liner is less than 18×10⁻¹¹ cm³·cm/(cm²·s·cmHg), wherein a thickness of the inner liner on a tire equatorial plane is 1.5 mm or less, and wherein a loss tangent at 70° C., 70° C. tan δ, of a complex of the insulation and the inner liner is 0.22 or less.

According to the present invention, a tire can be provided which improves in tire air permeation-suppressing performance.

Although it is not intended to be bound by theory, the reason why air permeation-suppressing performance can be improved is considered as follows. That is, the tan δ related to the complex of the insulation and the inner liner is decreased and a thickness of the complex is thinned, whereby it becomes difficult for the entire tire to generate heat, and it is considered that it becomes difficult for air to pass through. It is considered that, due to the synergistic effect between this matter and an improvement in air permeation coefficient of the inner liner, the tire contributes to an improvement in air permeation-suppressing performance by running.

### BRIEF DESCRIPTION OF THE DRAWINGS

FIG. 1 is a schematic view showing a part of a cross section of a tire relating to one embodiment of the present invention taken along a tire meridian line (the upper right-side part of the cross section).

### DETAILED DESCRIPTION

The tire relating to one embodiment of the present invention is a tire comprising an inner liner and an insulation touching the inner liner on an outer side of the inner liner in a tire radial direction, wherein the insulation is composed of a rubber composition comprising a recovered carbon black, wherein an air permeation coefficient of a rubber composition constituting the inner liner is less than 18×10⁻¹¹ cm³·cm/(cm²·s·cmHg), wherein a thickness of the inner liner on a tire equatorial plane is 1.5 mm or less, and wherein a loss tangent at 70° C., 70° C. tan δ, of a complex of the insulation and the inner liner is 0.22 or less.

The thickness of the inner liner on the tire equatorial plane is preferably 1.4 mm or less, more preferably 1.2 mm or less, further preferably 1.1 mm or less.

Strain of the inner liner is reduced, heat generation is suppressed, and it is considered that the air permeation-suppressing performance is improved.

The air permeation coefficient of the rubber composition constituting the inner liner is preferably 17×10⁻¹¹ cm³·cm/(cm²·s·cmHg) or less, more preferably 16×10⁻¹¹ cm³·cm/(cm²·s·cmHg) or less, further preferably less than 15×10⁻¹¹ cm³·cm/(cm²·s·cmHg), further preferably 14.0×10⁻¹¹ cm³·cm/(cm²·s·cmHg) or less.

Heat generation is suppressed as air is retained, shape stability is improved, and rolling resistance is reduced, which is considered to lead to a further improvement in air permeation-suppressing performance.

It is preferable that a rubber composition constituting the insulation comprises a rubber component comprising greater than 20% by mass of an isoprene-based rubber and the rubber composition constituting the inner liner comprises a rubber component comprising greater than 70% by mass of a butyl-based rubber.

It is preferable that a statistical thickness surface area (STSA), in m²/g, of the recovered carbon black is greater than 37 and less than 77 and an ash content, in % by mass, of the recovered carbon black is greater than 11 and less than 27.

### Definitions

A “standardized state” is a state in which a tire is rim-assembled to a standardized rim, filled with air at a standardized internal pressure, and applied with no load.

A “dimension of each part of a tire” is a value specified in a standardized state for one appearing on the outer surface of the tire, unless otherwise specified, while it is a value specified, for example, in a condition where the tire is cut on a plane including a tire rotation axis and the cut tire piece is held to a rim width of a standardized rim, for one present inside the tire or on a tire cutting surface.

A “tire weight” is represented by G, in kg and refers to a weight of a single tire excluding a weight of a rim. On the other hand, in a case where a member consisting of a sponge and a sealant, a sensor member, or the like is provided in a tire lumen, G shall be a weight including a weight of such a member.

A “standardized rim” is a rim, in a standard system including a standard on which the tire is based, defined by the standard for each tire. For example, the “standardized rim” refers to a standard rim of an applicable size described in “Jatma Year Book” in JATMA (The Japan Automobile Tyre Manufacturers Association, Inc.), “Measuring Rim” described in “STANDARDS MANUAL” in ETRTO (The European Tyre and Rim Technical Organisation), or “Design Rim” described in “YEAR BOOK” in TRA (The Tire and Rim Association, Inc.), to which references are made in this order, and if there is an applicable size at the time of the reference, the rim conforms to its standard. Besides, if the tire is not defined in the above-described standard system, the “standardized rim” refers to a rim having the narrowest rim width among rims that can be rim-assembled to the tire and retain internal pressure (that is, do not cause air leakage between the rim and the tire) and each of which has the smallest diameter.

A “standardized internal pressure” is an air pressure, in a standard system including a standard on which the tire is based, defined by the standard for each tire and refers to, for example, a “MAXIMUM AIR PRESSURE” in JATMA, “INFLATION PRESSURE” in ETRTO, or a maximum value described in Table “TIRE LOAD LIMITS AT VARIOUS COLD INFLATION PRESSURES” in TRA, to which references are made in this order as in the case of the standardized rim, and if there is an applicable size at the time of the reference, the standardized internal pressure conforms to its standard. Besides, in the case of tires that are not defined by the standard, the standardized internal pressure shall refer to a standardized internal pressure (250 KPa or more) of another tire size (specified in the standard) for which the standardized rim is described as a standard rim, and when a plurality of standardized internal pressures of 250 KPa or more are described, it shall refer to the minimum value among them.

A “standardized load” is a load, in a standard system including a standard on which the tire is based, defined by the standard for each tire, for example, a “MAXIMUM LOAD CAPACITY” in JATMA, a “LOAD CAPACITY” in ETRTO, or a maximum value described in Table “TIRE LOAD LIMITS AT VARIOUS COLD INFLATION PRESSURES” in TRA, to which references are made in this order as in cases of a standardized rim and a standardized internal pressure, and if there is an applicable size at the time of the reference, the load conforms to its standard. Then, in the case of tires that are not defined by the standard, a maximum load capacity WL obtained by another calculation is defined as a standardized load.

A “maximum load capacity WL” is calculated by the following equation. “V” represents a virtual volume, in mm³, of a tire, “Dt” represents a tire outer diameter, in mm, in a standardized state, “Ht” represents a cross-sectional height, in mm, of the tire in a tire radial direction on a cross section of the tire taken along a plane including a tire rotation axis, and “Wt” represents a cross-sectional width, in mm, of the tire in the standardized state. When R represents a rim diameter of the tire, Ht can be calculated by the following equation: (Dt-R)/2. Wt is a value obtained by excluding, if any, patterns, letters, or the like on the side surface of the tire. Besides, the maximum load capacity has the same meaning as the above-described standardized load.

$${W}_{L} = 0.000011 \times V + 175$$

$$V = [ {( Dt / 2 )}^{2} - {( Dt / 2 - H t )}^{2} \} \times π \times Wt$$

A “recovered carbon black” refers to carbon black that is obtained by a pyrolysis process of a product comprising carbon black such as a used tire and the like, in which a ratio of a mass of ash (ash content), which is a component that does not combust, is greater than 11% by mass when the product is subjected to oxidative combustion by heating in the air, using a thermal weight measurement method according to JIS K 6226-2:2003. That is, a mass (carbon amount) of a weight loss content due to oxidative combustion is less than 89% by mass. The recovered carbon black is also referred to as “recycled carbon” or “recycled carbon black” and may be expressed by rCB.

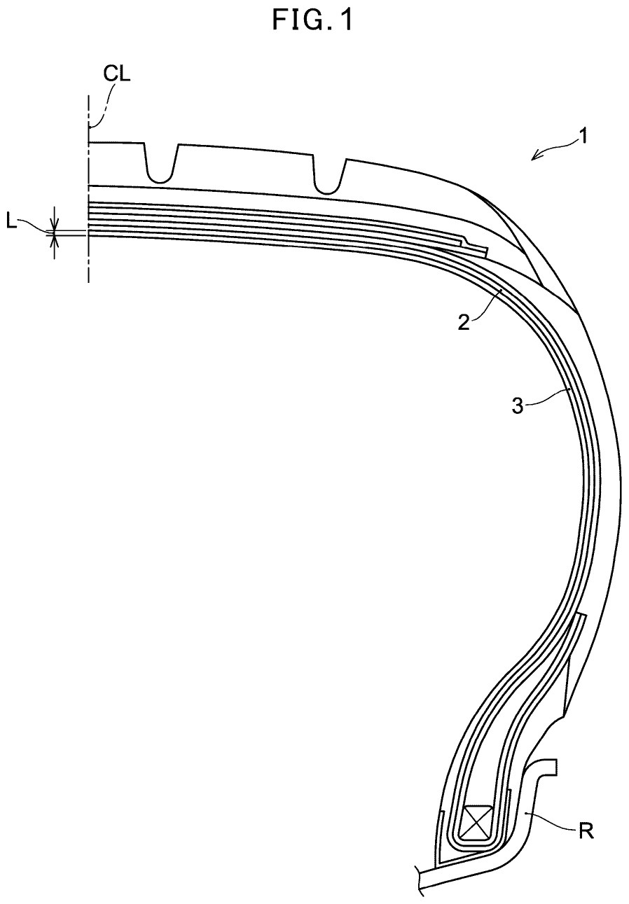

A “thickness of an inner liner” is a thickness in a tire radial direction on an equator on a cross section of a tire along a plane including a tire rotation axis and corresponds to L shown in FIG. 1. As the “thickness of an inner liner”, an average value of respective values measured on tire cross sections along the plane including the tire rotation axis at five sites of the tire rotated in 72 degree increments is used. Besides, the measurement can be performed by preparing a cross-sectional piece of the tire cut along the plane including the tire rotation axis and holding the cross-sectional piece in a state where a space between its beads is made to match a width of a standardized rim.

A “loss tangent of a rubber composition” is a loss tangent (tan δ) measured with an extension mode, using a dynamic viscoelasticity measuring device (for example, EPLEXOR series manufactured by gabo Systemtechnik GmbH), under each condition. A sample used for dynamic viscoelasticity measurement is a vulcanized rubber composition having a length of 20 mm, a width of 4 mm, and a thickness of 1 mm. In a case where the sample is prepared by being cut out from a tire, the direction of the length of the sample is made to match a tire circumferential direction, and the direction of the thickness of the sample is made to match a tire radial direction. In collecting a sample of a complex of an insulation and an inner liner, the sample is cut out so that a thickness of the complex including the entire thickness of the insulation becomes 1 mm by appropriately adjusting a thickness of the inner liner.

“70° C. tan δ” is a loss tangent (tan δ) measured under a condition of a temperature at 70° C., a frequency of 10 Hz, an initial strain of 10%, a dynamic strain of 1%, and an extension mode.

### <Measuring Methods>

### A “Styrene Content” is Calculated by Pyrolysis Gas Chromatography.

A “vinyl bond amount (1,2-bond butadiene unit amount)” is measured by infrared absorption spectrometry.

A “cis content (cis-1,4-bond butadiene unit amount)” is measured by infrared absorption spectrometry.

An “ash content of a recovered carbon black” is measured by a thermal weight measurement method of JIS K 6226-2:2003.

A “statistical thickness surface area (STSA) of a recovered carbon black” is a value calculated by JIS K 6217-7:2017. Moreover, a “nitrogen adsorption specific surface area (N₂SA) of a recovered carbon black” is a value calculated by JIS K 6217-2:2017.

An “average primary particle size of carbon black” and an “average primary particle size of a recovered carbon black” are values calculated by an arithmetic mean of particle sizes of 400 particles which are photographed with a transmission or scanning electron microscope. In a case that the particle is in a spherical shape, a diameter of the sphere is defined as a particle size, and in cases of shapes other than the spherical shape, an equivalent circle diameter (positive square root of “4×(area of particle)/π”) calculated from a microscope image is defined as a particle size.

An “nitrogen adsorption specific surface area (N₂SA) of silica” is a value measured by a BET method according to ASTM D3037-93.

An “air permeation coefficient” is a value measured according to Annex 2 of JIS K 7126-1 (a gas permeability testing method by a gas chromatography method).

### <Tire>

The tire relating to one embodiment of the present invention will be described below with reference to the drawings as appropriate. However, the drawings are merely examples for explanation.

FIG. 1 is a schematic view showing a part of a cross section of a tire relating to one embodiment of the present invention taken along a tire meridian line (the upper right-side part of the cross section). In FIG. 1, an inner liner 3 constitutes an inner surface of a tire 1 and retains internal pressure in the tire 1. An insulation 2 is adjacent to the outer side of the inner liner in a tire rotation axis direction, and the inner liner is joined to another member such as a carcass and the like via the insulation. A thickness of the inner liner along a tire center line is represented by L.

The thickness L, in mm, of the inner liner on a tire equatorial plane is 1.5 mm or less, preferably 1.4 mm or less, more preferably 1.2 mm or less, further preferably 1.1 mm or less. Its lower limit is not particularly limited and is, for example, 0.01 mm or more. Strain together with heat generation by the inner liner is suppressed, and thus it is considered that air permeation resistance is improved.

Moreover, since the rubber composition for inner liner relating to one embodiment of the present invention is molded to form an inner cavity surface of the tire and is used for the inner liner having a function of reducing an amount of air permeation to retain internal pressure of the tire, an excellent air permeation resistance is required. For the reason that the excellent air permeation suppressibility required for the inner liner can be obtained, an air permeation coefficient of the rubber composition is less than 18×10⁻¹¹ cm³·cm/(cm²·s·cmHg), preferably 17×10⁻¹¹ cm³·cm/(cm²·s·cmHg) or less, more preferably 16×10⁻¹¹ cm³·cm/(cm²·s·cmHg) or less, further preferably 15×10⁻¹¹ cm³·cm/(cm²·s·cmHg) or less, further preferably 14.0×10⁻¹¹ cm³·cm/(cm²·s·cmHg) or less. Its lower limit is not particularly limited and is, for example, 1.0×10⁻¹³ cm³·cm/(cm²·s·cmHg) or more.

The air permeation coefficient can be changed by changing a type or a content of a rubber component, a filler, a resin component, or the like in the rubber composition. Specifically, for example, the air permeation coefficient can be decreased by increasing an amount of the filler or decreasing its particle size.

A loss tangent at 70° C., 70° C. tan δ, of a complex of the inner liner and the insulation is 0.22 or less, preferably 0.21 or less, more preferably 0.20 or less. Its lower limit is not particularly limited and is, for example, 0.01 or more. Suppression of heat generation is improved and thus it is considered that air permeation resistance is improved. 70° C. tan δ can be appropriately adjusted depending on types or compounding amounts of a polymer component, a filer, oil, a resin component, and the like that are described below. For example, 70° C. tan δ tends to be able to be increased by increasing an amount of a filler, reducing its particle size, decreasing amounts of a vulcanizing agent and a vulcanization accelerator, or the like, and 70° C. tan δ tends to be able to be decreased by reverse operations.

Moreover, a loss tangent at 70° C. of a rubber composition constituting the insulation is, for example, less than 0.185, preferably 0.18 or less, more preferably 0.17 or less, further preferably 0.15 or less. When it is within these ranges, it is considered that air permeation resistance is further improved.

Moreover, a loss tangent at 70° C. of the rubber composition constituting the inner liner is, for example, less than 0.25, preferably 0.24 or less, more preferably 0.22 or less, further preferably 0.21 or less. When it is within these ranges, it is considered that air permeation resistance is further improved.

### <Rubber Composition>

A rubber composition for insulation and a rubber composition for inner liner will be described below.

### <Rubber Composition for Insulation>

Each component of the rubber composition for insulation will be described. The rubber composition constituting the insulation comprises a recovered carbon black.

### <Rubber Component>

The rubber composition constituting the insulation comprises a rubber component comprising an isoprene-based rubber (IR-based rubber) and a styrene-butadiene rubber (SBR). In this case, the rubber component can comprise a rubber component other than the IR-based rubber and the SBR. Moreover, the rubber component may be one consisting of the IR-based rubber and the SBR. An explanation of each of rubbers capable of constituting the rubber component is as follows.

(Isoprene-Based Rubber) Examples of the isoprene-based rubber include a natural rubber (NR), an isoprene rubber (IR), a refined NR, a modified NR, a modified IR, and the like. For example, those common in the rubber industry such as SIR20, RSS #3, TSR20, SVR-L, and the like can be used as the NR. The IR is not particularly limited, and for example, those common in the rubber industry such as IR2200 and the like can be used. Examples of the refined NR include a deproteinized natural rubber (DPNR), an ultra pure natural rubber (UPNR), and the like, examples of the modified NR include an epoxidized natural rubber (ENR), a hydrogenated natural rubber (HNR), a grafted natural rubber, and the like, and examples of the modified IR include an epoxidized isoprene rubber, a hydrogenated isoprene rubber, a grafted isoprene rubber, and the like. The isoprene-based rubbers may be used alone, or two or more thereof may be used in combination.

A content of an IR-based rubber in 100% by mass of the rubber component is, for example, greater than 20% by mass, preferably greater than 30% by mass, more preferably greater than 40% by mass, further preferably 50% by mass or more. On the other hand, the content is, for example, 100% by mass or less, preferably less than 90% by mass, more preferably less than 80% by mass.

### (SBR)

The styrene-butadiene rubber (SBR) is not particularly limited, examples of which include, for example, an unmodified emulsion-polymerized styrene-butadiene rubber (E-SBR), an unmodified solution-polymerized styrene-butadiene rubber (S-SBR), and modified SBRs obtained by modifying these SBRs, such as a modified emulsion-polymerized styrene-butadiene rubber (modified E-SBR) and a modified solution-polymerized styrene-butadiene rubber (modified S-SBR), and the like. Examples of the modified SBR include a modified SBR modified at its terminal and/or main chain, a modified SBR coupled with tin, a silicon compound, etc. (a modified SBR of condensate or having a branched structure, etc.), and the like. Moreover, types of the SBR include an oil-extended type whose flexibility is adjusted by addition of an extending oil and a non-oil-extended type to which no extending oil is added, any of which can be used. As such an SBR, for example, products from JSR Corporation, Asahi Chemicals Co., Ltd., Zeon Corporation, ZS Elastomer Co., Ltd., etc. can be used. The SBR may be used alone, or two or more thereof may be used in combination.

A styrene content of an SBR is preferably greater than 15% by mass, more preferably greater than 20% by mass, further preferably greater than 23% by mass. Moreover, the styrene content is preferably less than 40% by mass, more preferably less than 30% by mass, further preferably less than 25% by mass, from the viewpoint of fuel efficiency. Besides, the styrene content of an SBR is a value calculated by the ¹H-NMR measurement.

A vinyl content (1,2-bond butadiene unit amount) of an SBR is preferably greater than 10% by mass, more preferably greater than 15% by mass. Moreover, the vinyl content is preferably less than 80% by mass, preferably less than 50% by mass, more preferably less than 30% by mass. Besides, the vinyl content of the SBR is a value measured by infrared absorption spectrometry.

A content of an SBR-based rubber in 100% by mass of the rubber component is, for example, greater than 5% by mass, preferably greater than 10% by mass, more preferably greater than 20% by mass, further preferably greater than 25% by mass. On the other hand, the content is, for example, 100% by mass or less, preferably less than 90% by mass, more preferably less than 80% by mass.

Moreover, a total content of an IR-based rubber and an SBR in 100% by mass of the rubber component is preferably greater than 80% by mass, more preferably greater than 90% by mass, further preferably greater than 95% by mass, or may be 100% by mass.

### (Other Rubbers)

Other usable rubbers other than the above-described rubbers are not particularly limited, and rubbers used in the tire field and the like can be used as such other rubbers. Examples of the other usable rubbers include, for example, diene-based rubbers such as a butadiene rubber (BR), an acrylonitrile-butadiene rubber (NBR), a chloroprene rubber (CR), a styrene-isoprene-butadiene copolymer rubber (SIBR), and the like. These other rubbers may be used alone, or two or more thereof may be used in combination.

### (BR)

The BR is not particularly limited, and examples of the BR include those common in the tire industry, such as, for example, a BR having a high cis content, a BR containing a 1,2-syndiotactic polybutadiene crystal (SPB-containing BR), a butadiene rubber synthesized using a rare-earth element-based catalyst (a rare-earth-based BR), a tin-modified butadiene rubber modified by a thin compound (tin-modified BR), a modified butadiene rubber other than these BRs (modified BR), and the like. As a commercially available product of the BR, products from UBE Corporation, JSR Corporation, Asahi Kasei Corporation, Ltd., Zeon Corporation, etc. can be used. The modified BR may be a BR having a functional group interacting with a filler such as silica and the like. Examples of the modified BR include, for example, a terminal-modified BR obtained by modifying at least one terminal of a BR with a compound (a modifying agent) having the above-described functional group (terminal-modified BR having the above-described functional group at its terminal), a main chain modified BR whose main chain has the above-described functional group, a main chain terminal-modified BR having the above-described functional groups on its main chain and at its terminal (for example, a main chain terminal-modified BR whose main chain has the above-described functional group and at least one terminal of which is modified with the above-described modifying agent), a terminal-modified BR which is modified (coupled) with a polyfunctional compound having two or more epoxy groups in a molecule and into which a hydroxyl group or an epoxy group is introduced, and the like. Examples of the above-described functional group include, for example, an amino group, an amido group, a silyl group, an alkoxysilyl group, an isocyanate group, an imino group, an imidazole group, an urea group, an ether group, a carbonyl group, an oxycarbonyl group, a mercapto group, a sulfide group, a disulfide group, a sulfonyl group, a sulfinyl group, a thiocarbonyl group, an ammonium group, an imide group, a hydrazo group, an azo group, a diazo group, a carboxyl group, a nitrile group, a pyridyl group, an alkoxy group, a hydroxyl group, an oxy group, an epoxy group, and the like. Besides, these functional groups may have a substituent. Among them, an amino group (preferably an amino group whose hydrogen atom is substituted with an alkyl group having 1 to 6 carbon atoms), an alkoxy group (preferably an alkoxy group having 1 to 6 carbon atoms), and an alkoxysilyl group (preferably an alkoxysilyl group having 1 to 6 carbon atoms) are preferable.

A cis amount (cis content) of a BR is preferably greater than 90% by mass, more preferably greater than 93% by mass, further preferably greater than 95% by mass, further preferably 97% by mass or more. The cis amount of the BR can be measured by infrared absorption spectrometry.

As the BR, for example, products from UBE Corporation, JSR Corporation, Asahi Kasei Corporation, Ltd., Zeon Corporation, etc. can be used. The BR may be used alone, or two or more thereof may be used in combination.

(Rubber Component Synthesized from Recycle-Derived/Biomass-Derived Raw Material)

A monomer that is a structural unit of a synthetic rubber such as an IR, an SBR, a BR, and the like may be one derived from underground resources such as petroleum, a natural gas, and the like or one recycled from a rubber product such as a tire and the like or a non-rubber product such as polystyrene and the like. Examples of monomers obtained by recycle (recycled monomers) include, but not particularly limited to, a recycle-derived polyisoprene, a recycle-derived butadiene, a recycle-derived aromatic vinyl compound, and the like. Examples of the above-described butadiene include 1,2-butadiene and 1-3 butadiene. Examples of the aromatic vinyl compound include, but not particularly limited to, styrene and the like. Among them, a recycle-derived polyisoprene (recycled isoprene), a recycle-derived butadiene (recycled butadiene), and/or a recycle-derived styrene (recycled styrene) are preferably used as raw materials.

A method of producing a recycled monomer is not particularly limited, examples of which include, for example, synthesis of a recycled monomer from recycle-derived naphtha obtained by decomposing a rubber product such as a tire and the like. Moreover, a method of producing a recycle-derived naphtha is not particularly limited and may be performed, for example, by decomposing a rubber product such as a tire and the like under high temperature and pressure, by decomposing it by microwaves, or by extracting it after mechanically pulverizing it.

Furthermore, a monomer that is a structural unit of a polymer such as an IR, an SBR, a BR, and the like may be one derived from biomass. In the present specification, “biomass” refers to a material derived from natural resources such as plants and the like. Examples of biomass include, but not particularly limited to, for example, agricultural, forest and fishery products and sugar, wood waste, a plant residue after acquisition of a useful component, a plant-derived ethanol, a biomass naphtha, and the like. Examples of the biomass-derived monomer (biomass monomer) include, but not particularly limited to, a biomass-derived butadiene, a biomass-derived aromatic vinyl compound, and the like. Examples of the above-described butadiene include 1, 2-butadiene and 1,3-butadiene. Examples of the above-described aromatic vinyl compound include, but not particularly limited to, styrene and the like. Moreover, a method of producing a biomass monomer is not particularly limited, examples of which include, for example, a method by biological and/or chemical and/or physical conversion of an animal or a plant. A microbial fermentation is representative of biological conversion, and examples of chemical and/physical conversion include a method using a catalyst, a method using a high heat, a method using a high pressure, a method using an electromagnetic wave, a method using a critical liquid, and combinations thereof.

Examples of a polymer synthesized from a biomass monomer component (biomass polymer) include, but not particularly limited to, a polybutadiene rubber synthesized from a biomass-derived butadiene, an aromatic vinyl/butadiene copolymer synthesized from a biomass-derived butadiene and/or a biomass-derived aromatic vinyl compound, and the like. Examples of the aromatic vinyl/butadiene copolymer include, for example, a styrene-butadiene rubber synthesized from a biomass-derived butadiene and/or a biomass-derived styrene, and the like.

Whether or not a raw material of a polymer is derived from biomass can be determined from percent Modern Carbon (pMC) measured according to ASTM D6866-10.

“pMC” means a ratio of ¹⁴C concentration of a sample to ¹⁴C concentration of a modern standard carbon (modern standard reference) and is a value used as an index that indicates a biomass ratio of a compound. A significance of this value will be mentioned below.

In 1 mole of carbon atoms (about 6.02×10²³), there are about 6.02×10^{11 14}C that are about one trillionth of the number of normal carbon atoms. A half-life of ¹⁴C is 5730 years, and ¹⁴C regularly decreases. Therefore, in fossil fuels such as coal, petroleum, natural gas, and the like, where it is considered that 226,000 years or more have passed since carbon oxide in the atmosphere was absorbed by plants to be fixed, all of ¹⁴C elements, which were contained in them at the beginning of fixation, decay. Therefore, in the present 21st century, fossil fuels such as coal, petroleum, natural gas, and the like do not contain any ¹⁴C element. Accordingly, chemical substances produced using these fossil fuels as raw materials do not contain any ¹⁴C element as well.

On the other hand, ¹⁴C is constantly generated by cosmic rays causing nuclear reactions in the atmosphere. Therefore, decrease in ¹⁴C due to radioactive decay and generation of ¹⁴C due to nuclear reactions are balanced, and the amount of ¹⁴C has been constant in the atmosphere environment of the earth. Therefore, the ¹⁴C concentration of substances derived from biomass resources that have been circulating in the current environment becomes a value of about 1×10⁻¹² mol % based on the entire C atoms, as described above. Accordingly, by utilizing a difference between these values, a ratio of biomass in a certain compound can be calculated.

This ¹⁴C is generally measured as follows. A ¹³C concentration (¹³C/¹²C) and a ¹⁴C concentration (¹⁴C/¹²C) are measured using an accelerator mass spectrometry based on a tandem accelerator. In the measurements, a ¹⁴C concentration in a circulating carbon in nature as of 1950 is adopted as the modern standard reference for the ¹⁴C concentration. As a specific reference material, an oxalic acid standard body provided by NIST (National Institute of Standard and Technology) is used. A specific radioactivity of carbon in this oxalic acid (radioactivity intensity of ¹⁴C per gram of carbon) is sorted for each carbon isotope, ¹³C is corrected to be a constant value, and a value corrected for attenuation correction from 1950 to the date of measurement is used as a standard ¹⁴C concentration value (100%). A ratio of this value and a value actually measured for a sample becomes a pMC value.

Thus, if a rubber is produced from a material derived from 100% biomass, the ¹⁴C concentration shows a value of approximately 110 pMC as, currently, under a normal condition, it is often not equal to 100, though there are regional differences and the like. On the other hand, if this ¹⁴C concentration is measured for a chemical substance derived from a fossil fuel such as petroleum and the like, it shows a value of approximately 0 pMC (for example, 0.3 pMC). This value corresponds to a biomass ratio of 0% as mentioned above.

From above, it is appropriate in terms of environmental protection to use a material such as a rubber having a high pMC value, that is, a material such as a rubber having a high biomass ratio, for a rubber composition.

### <Filler>

The rubber composition for insulation relating to an embodiment of the present invention comprises a filler comprising a recovered carbon black (rCB). Moreover, the filler may comprise carbon black, silica, or another reinforcing filler used in the tire industry. Preferably, the filler comprises a recovered carbon black and another carbon black other than the recovered carbon black. In a case where the filler comprises silica, the filler can further comprise a silane coupling agent.

### (Recovered Carbon Black)

In the present invention, a recovered carbon black refers to carbon black that is obtained by a pyrolysis process of a product comprising carbon black such as a used tire and the like, in which a ratio of a mass of ash (ash content), which is a component that does not combust, is greater than 11% by mass when the product is subjected to oxidative combustion by heating in the air, using a thermal weight measurement method according to JIS K 6226-2:2003. The ash content of a recovered carbon black is preferably 13% by mass or more, more preferably 15% by mass or more, further preferably 16% by mass or more, further preferably 17% by mass or more. Moreover, the ash content is preferably less than 27% by mass, more preferably less than 26% by mass, further preferably less than 25% by mass.

A recovered carbon black can be obtained from a pyrolysis process of a used pneumatic tire. For example, EP 3427975 A refers to “Rubber Chemistry and Technology”, vol. 85, No. 3, pp. 408-449 (2012), particularly, pages 438, 440, and 442 and describes that a recovered carbon black can be obtained by pyrolysis of an organic material at 550 to 800° C. under an environment in which oxygen is eliminated or by vacuum pyrolysis at a relatively low temperature ([0027]). As described in [0004] of JP 6856781 B, such carbon black obtained by the pyrolysis process usually lacks a functional group on its surface (A Comparison of Surface Morphology and Chemistry of Pyrolytic Carbon Blacks with Commercial Carbon Blacks, Powder Technology 160 (2005) 190-193). As described above, since a recovered carbon black has few surface functional groups, its interaction with the rubber component becomes small, and it is considered that heat generation due to friction with a rubber is reduced.

The recovered carbon black may be one that lacks a functional group on its surface or may be one treated so as to include a functional group on its surface. The treatment of the recovered carbon black so that the recovered carbon black includes a functional group on its surface can be performed by a usual method. For example, in EP 3173251 A, carbon black obtained from a pyrolysis process is treated with potassium permanganate under an acidic condition, thereby obtaining carbon black including a hydroxyl group and/or a carboxyl group on its surface. Moreover, in JP 6856781 B, carbon black obtained from a pyrolysis process is treated with an amino acid compound including at least one thiol group or disulfide group, thereby obtaining carbon black whose surface is activated. Examples of the recovered carbon black relating to an embodiment of the present invention also include carbon black treated so as to include a functional group on its surface.

An average primary particle size of a recovered carbon black is preferably 20 nm or more, more preferably 25 nm or more, further preferably 30 nm or more, particularly preferably 35 nm or more. When the average primary particle size of carbon black is within the above-described ranges, rubber molecules bound by carbon black are minimized, and it becomes easy for the rubber molecules to flexibly move. Accordingly, it is considered that, for an input, stress can be mitigated even by polymer molecule chains. On the other hand, the average primary particle size is preferably 90 nm or less, more preferably 75 nm or less, further preferably 60 nm or less. Besides, the average primary particle size of carbon black is measured by the above-described measuring method.

A nitrogen adsorption specific surface area (N₂SA) of a recovered carbon black is, but not particularly limited to, preferably greater than 30 m²/g, more preferably greater than 40 m²/g, further preferably greater than 50 m²/g, further preferably greater than 60 m²/g, further preferably greater than 70 m²/g, from the viewpoint that a sufficient reinforcing property and a good abrasion resistance can be obtained. Moreover, the N₂SA is preferably less than 300 m²/g, more preferably less than 200 m²/g, further preferably less than 150 m²/g, further preferably less than 120 m²/g, further preferably less than 110 m²/g, further preferably less than 100 m²/g, further preferably less than 90 m²/g, from the viewpoint that the recovered carbon black is excellent in dispersibility and is less likely to generate heat. Besides, the N₂SA of the recovered carbon black in the present specification is a value measured according to JIS K 6217-2:2017.

A statistical thickness surface area (STSA) of a recovered carbon black is, but not particularly limited to, preferably greater than 37 m²/g, more preferably greater than 40 m²/g, further preferably greater than 45 m²/g, from the viewpoint that a sufficient reinforcing property and a good abrasion resistance can be obtained. Moreover, the STSA is preferably less than 77 m²/g, more preferably less than 75 m²/g, further preferably less than 73 m²/g, from the viewpoint that the recovered carbon black is excellent in dispersibility and is less likely to generate heat. Besides, the STSA of the recovered carbon black in the present specification is a value measured according to JIS K 6217-7:2017.

A content of a recovered carbon black based on 100 parts by mass of the rubber component is, for example, greater than 10 parts by mass, preferably greater than 20 parts by mass, more preferably 30 parts by mass or more, further preferably greater than 50 parts by mass, from the viewpoint of reinforcing property.

(Carbon Black Other than rCB)

Examples of carbon black other than the recovered carbon black include, but not particularly limited to, N134, N110, N220, N234, N219, N339, N330, N326, N351, N550, N762, and the like. A raw material of carbon black may be a biomass material such as lignin, vegetable oil, and the like or may be pyrolysis oil obtained by pyrolyzing a waste tire. Moreover, a method of producing carbon black may be a method using combustion such as a furnace method, may be a method using hydrothermal carbonization (HTC), or may be a method using pyrolysis of methane by a thermal black method and the like. As a commercially available product, products from ASAHI CARBON CO., LTD., Cabot Japan K.K., TOKAI CARBON CO., LTD., Mitsubishi Chemical Corporation., Lion Corporation., NIPPON STEEL Carbon Co., Ltd., Columbia Carbon Corporation., etc. can be used. They may be used alone, or two or more thereof may be used in combination.

An average primary particle size of carbon black is preferably 20 nm or more, more preferably 25 nm or more, further preferably 30 nm or more, particularly preferably 35 nm or more. When the average primary particle size of carbon black is within the above-described ranges, rubber molecules bound by carbon black are minimized, and it becomes easy for the rubber molecules to flexibly move. Accordingly, it is considered that, for an input, stress can be mitigated even by polymer molecule chains. On the other hand, the average primary particle size is preferably 90 nm or less, more preferably 75 nm or less, further preferably 60 nm or less. Besides, the average primary particle size of carbon black is measured by the above-described measuring method.

A nitrogen adsorption specific surface area (N₂SA) of carbon black is, but not particularly limited to, preferably greater than 30 m²/g, more preferably greater than 40 m²/g, further preferably greater than 50 m²/g, further preferably greater than 60 m²/g, further preferably greater than 70 m²/g, from the viewpoint that a sufficient reinforcing property and a good abrasion resistance can be obtained. Moreover, the N₂SA is preferably less than 300 m²/g, more preferably less than 200 m²/g, further preferably less than 150 m²/g, further preferably less than 120 m²/g, further preferably less than 110 m²/g, further preferably less than 100 m²/g, further preferably less than 90 m²/g, from the viewpoint that carbon black is excellent in dispersibility and is less likely to generate heat. Besides, the N₂SA of carbon black in the present specification is a value measured according to JIS K 6217-2:2017.

A statistical thickness surface area (STSA) of carbon black is, but not particularly limited to, preferably greater than 37 m²/g, more preferably greater than 40 m²/g, further preferably greater than 45 m²/g, from the viewpoint that a sufficient reinforcing property and a good abrasion resistance can be obtained. Moreover, the STSA is preferably less than 77 m²/g, more preferably less than 75 m²/g, further preferably less than 73 m²/g, from the viewpoint that carbon black is excellent in dispersibility and is less likely to generate heat. Besides, the STSA of carbon black in the present specification is a value measured according to JIS K 6217-7:2017.

### (Content of Carbon Black)

A content of carbon black when compounded based on 100 parts by mass of the rubber component is, for example, greater than 10 parts by mass, preferably greater than 20 parts by mass, more preferably 30 parts by mass or more. A total content of carbon black comprising a recovered carbon black based on 100 parts by mass of the rubber component is, for example, greater than 20 parts by mass, preferably greater than 30 parts by mass, more preferably greater than 40 parts by mass, further preferably greater than 50 parts by mass, further preferably 60 parts by mass or more. On the other hand, the total content is preferably less than 100 parts by mass, more preferably less than 90 parts by mass, further preferably less than 80 parts by mass. When the content of carbon black is within the above-described ranges, a sufficient reinforcing property and a good dispersion in a rubber are obtained, so that a sufficient rubber strength and a sufficient crack growth resistance tend to be obtained.

### (Silica)

Silica is not particularly limited, and those common in the tire industry can be used, such as, for example, silica prepared by a dry process (anhydrous silica), silica prepared by a wet process (hydrous silica), and the like. A raw material of silica is not particularly limited and may be, for example, a raw material derived from a mineral such as quartz or a raw material derived from a biological substance such as rice husks (for example, silica made from a biomass material such as rice husks, and the like), or silica recycled from a product containing silica may be used. Among them, hydrous silica prepared by a wet process is preferable for the reason that it has many silanol groups. The silica may be used alone, or two or more thereof may be used in combination.

Silica made from a biomass material can be obtained by, for example, burning rice husks to obtain rice husk ashes, extracting silicate from the rice husk ashes using a sodium hydroxide solution, generating silicon dioxide by reacting the silicate with sulfuric acid in the same manner as a conventional wet silica, and filtering, washing with water, drying and pulverizing precipitates of the silicon dioxide.

As silica recycled from a product comprising silica, for example, silica recovered from an electronic component such as a semiconductor and the like, a tire, a product containing silica such as a desiccant, a filtering material such as diatomaceous earth and the like, and the like, etc., can be used. Moreover, a recovering method is not particularly limited, examples of which include pyrolysis, decomposition by electromagnetic waves, and the like. Among them, silica recovered from an electronic component such as a semiconductor and the like or from a tire is preferable.

When silica crystallizes, it is insoluble in water, and silicic acid that is a component thereof cannot be used. By controlling a burning temperature and a burning time, crystallization of silica in rice husk ashes can be suppressed (see JP 2009-2594 A, Akita Prefectural University Web Journal B/2019, vol. 6, p.216-222, etc.).

As an amorphous silica extracted from rice husks, those commercially available from Wilmar, etc. can be used.

A nitrogen adsorption specific surface area (N₂SA) of silica is preferably greater than 50 m²/g, more preferably greater than 100 m²/g, further preferably greater than 150 m²/g, particularly preferably greater than 170 m²/g. Moreover, an upper limit of the N₂SA of silica is, but not particularly limited to, preferably less than 350 m²/g, more preferably less than 250 m²/g, further preferably less than 200 m²/g. When the content is within the above-described ranges, cut resistance tends to be improved. Besides, the N₂SA of silica is a value measured by a BET method according to ASTM D3037-93.

### (Content of Silica)

A content of silica when compounded based on 100 parts by mass of the rubber component is, but not particularly limited to, preferably greater than 1 part by mass, preferably greater than 5 parts by mass, more preferably greater than 10 parts by mass, further preferably greater than 20 parts by mass, from the viewpoint of securing fuel efficiency and ride comfort. Moreover, the content is preferably less than 150 parts by mass, more preferably less than 100 parts by mass, further preferably less than 50 parts by mass, further preferably less than 30 parts by mass, from the viewpoints of dispersibility of silica and processability.

### (Silane Coupling Agent)

In a case where silica is used as a filler, a rubber composition preferably further comprises a silane coupling agent. Examples of the silane coupling agent include, but not particularly limited to, for example, sulfide-based ones such as bis(3-triethoxysilylpropyl)tetrasulfide, bis(2-triethoxysilylethyl)tetrasulfide, bis(4-triethoxysilylbutyl)tetrasulfide, bis(3-trimethoxysilylpropyl)tetrasulfide, bis(2-trimethoxysilylethyl)tetrasulfide, bis(2-triethoxysilylethyl)trisulfide, bis(4-trimethoxysilylbutyl)trisulfide, bis(3-triethoxysilylpropyl)disulfide, bis(2-triethoxysilylethyl)disulfide, bis(4-triethoxysilylbutyl)disulfide, bis(3-trimethoxysilylpropyl)disulfide, bis(2-trimethoxysilylethyl)disulfide, bis(4-trimethoxysilylbutyl)disulfide, 3-trimethoxysilylpropyl-N, N-dimethylthiocarbamoyl tetrasulfide, 2-triethoxysilylethyl-N, N-dimethylthiocarbamoyl tetrasulfide, 3-triethoxysilylpropyl methacrylate monosulfide, and the like; mercapto-based ones such as 3-mercaptopropyltrimethoxysilane, 2-mercaptoethyltriethoxysilane, NXT and NXT-Z100 manufactured by Momentive Performance Materials, and the like; vinyl-based ones such as vinyltriethoxysilane, vinyltrimethoxysilane, and the like; amino-based ones such as 3-aminopropyltriethoxysilane, 3-aminopropyltrimethoxysilane, and the like; glycidoxy-based ones such as γ-glycidoxypropyltriethoxysilane, γ-glycidoxypropyltrimethoxysilane, and the like; nitro-based ones such as 3-nitropropyltrimethoxysilane, 3-nitropropyltriethoxysilane, and the like; and chloro-based ones such as 3-chloropropyltrimethoxysilane, 3-chloropropyltriethoxysilane, and the like. As a commercially available product, products from Evonik Industries AG, Momentive Performance Materials, Shin-Etsu Chemical Co., Ltd., Tokyo Chemical Industry Co, Ltd., AZmax.co, Dow Corning Toray Co., Ltd., etc. can be used. These silane coupling agents may be used alone, or two or more thereof may be used in combination.

### (Content of Silane Coupling Agent)

A content of a silane coupling agent when compounded based on 100 parts by mass of silica is preferably greater than 1 part by mass, more preferably greater than 3 parts by mass, further preferably greater than 5 parts by mass, further preferably greater than 7 parts by mass. On the other hand, the content is preferably less than 20 parts by mass, more preferably less than 18 parts by mass, further preferably less than 16 parts by mass, further preferably less than 14 parts by mass. When the content is within the above-described ranges, dispersibility of the silica tends to be improved.

### (Other Fillers)

Other fillers are not particularly limited, and materials known in the field of the tire industry can be used as other fillers. Examples of such other fillers include, for example, inorganic fillers such as calcium carbonate, talc, alumina, clay, aluminum hydroxide, aluminum oxide, mica, and the like. They may be used alone, or two or more thereof may be used in combination.

### <Other Compounding Agents>

The rubber composition can appropriately comprise compounding agents conventionally and commonly used in the tire industry, for example, a plasticizing agent, processing aid, a vulcanized rubber particle, wax, stearic acid, zinc oxide, an antioxidant, a vulcanizing agent, a vulcanization accelerator, and the like, in addition to the rubber component and the filler.

### (Plasticizing Agent)

The plasticizing agent is a material giving a rubber component plasticity and is a concept including both a plasticizing agent that is a liquid (in a liquid state) at normal temperature (25° C.) and a plasticizing agent that is solid at normal temperature (25° C.). Examples of the plasticizing agent include a resin component, oil, a liquid polymer, an ester-based plasticizing agent, and the like. These plasticizing agents may be ones derived from petroleum, ones derived from biomass, or ones derived from naphtha recycled from a rubber product or non-rubber product. Moreover, low-molecular-weight hydrocarbon components obtained by pyrolyzing used tires or products containing various components and extracting them may be used as plasticizing agents. These plasticizing agents may be used alone, or two or more thereof may be used in combination.

### <<Oil>>

Examples of oil include, for example, mineral oils, vegetable oils, animal oils, and the like. Moreover, from the viewpoint of a life cycle assessment, one obtained by refining a waste oil after use for a rubber mixing machine or an engine or waste cooking oil used in a cooking facility may also be used. The oils may be used alone, or two or more thereof may be used in combination.

In the present specification, “mineral oil” refers to oil derived from mineral resources such as petroleum, natural gas, and the like. Examples of mineral oil include paraffinic oils (mineral oils), naphthenic oils, aromatic oils, and the like. Specific examples of the mineral oils include, for example, MES (Mild Extracted Solvate), DAE (Distillate Aromatic Extract), TDAE (Treated Distillate Aromatic Extract), TRAE (Treated Residual Aromatic Extract), RAE (Residual Aromatic Extract), and the like. Moreover, as an environmental measure, oils each having a low content of a polycyclic aromatic compound (PCA) can also be used. Examples of the oils each having a low content of a PCA include MES, TDAE, heavy naphthenic oil, and the like.

In the present specification, examples of the vegetable oils include, for example, a linseed oil, a rapeseed oil, a safflower oil, a soybean oil, a corn oil, a cottonseed oil, a rice bran oil, a tall oil, a sesame oil, perilla oil, a castor oil, a tung oil, a pine oil, a pine tar oil, a sunflower oil, a coconut oil, a palm oil, a palm kernel oil, an olive oil, a camellia oil, a jojoba oil, a macadamia nut oil, a peanut oil, a grapeseed oil, a Japan wax, and the like. Furthermore, examples of the vegetable oil also include a refined oil obtained by refining the above-described oil (a salad oil, etc.), a transesterified oil obtained by transesterifying the above-described oil, a hydrogenated oil obtained by hydrogenating the above-described oil, a thermally polymerized oil obtained by thermally polymerizing the above-described oil, an oxidized polymerized oil obtained by oxidizing the above-described oils, a waste cooking oil obtained by recovering what was utilized as an edible oil, etc., and the like. Besides, the vegetable oil may be liquid or solid at normal temperature (25° C.). These vegetable oils may be used alone, or two or more thereof may be used in combination.

The vegetable oil relating to the present embodiment preferably comprises acylglycerol, and more preferably comprises triacylglycerol. Besides, in the present specification, acylglycerol refers to a compound in which a hydroxy group of glycerin and a fatty acid are ester-bonded. The acylglycerol is not particularly limited and may be 1-monoacylglycerol, 2-monoacylglycerol, 1, 2-diacylglycerol, 1, 3-diacylglycerol, or triacylglycerol. Furthermore, the acylglycerol may be a monomer, a dimer, or a multimer that is a trimer or higher. Besides, acylglycerol that is a dimer or higher can be obtained by thermal polymerization, oxidative polymerization, or the like. Moreover, the acylglycerol may be liquid or solid at normal temperature (25° C.).

Whether the rubber composition comprises the above-described acylglycerol can be confirmed by, but not particularly limited to, ¹H-NMR measurement. For example, a heavy chloroform in which a rubber composition containing triacylglycerol is immersed at normal temperature (25° C.) for 24 hours and then removed is subjected to ¹H-NMR measurement at room temperature, and signals near 5.26 ppm, near 4.28 ppm, and near 4.15 ppm are observed under condition that a signal of tetramethylsilane (TMS) is set to 0.00 ppm. These signals are presumed to be derived from hydrogen atoms bonded to carbon atoms adjacent to oxygen atoms of an ester group. Besides, “near” in this paragraph shall be a range of ±0.10 ppm.

The above-described fatty acid is not particularly limited and may be an unsaturated fatty acid or a saturated fatty acid. Examples of the unsaturated fatty acid include monounsaturated fatty acids such as oleic acid and the like; and polyunsaturated fatty acids such as linoleic acid, linolenic acid, and the like. Moreover, examples of the saturated fatty acid include butyric acid, lauric acid, and the like.

Among them, as the above-described fatty acid, a fatty acid having few double bonds, that is, a saturated fatty acid or a monounsaturated fatty acid is desired, and oleic acid is preferable. As a vegetable oil comprising such fatty acid, for example, a vegetable oil comprising a saturated fatty acid or a monounsaturated fatty acid or a vegetable oil refined by transesterification or the like may be used. Moreover, in order to produce a vegetable oil comprising such fatty acid, a plant may be improved by selective breeding, gene recombination, genome editing, or the like.

As a vegetable oil, for example, those commercially available from Idemitsu Kosan Co., Ltd., SankyoYuka Kogyo K. K., ENEOS Corporation, Olisoy, H&R Group, HOKOKU Corporation, Fuji Kosan Co., Ltd., The Nisshin Oillio Group, etc. can be used.

A content of oil based on 100 parts by mass of the rubber component is preferably greater than 1 part by mass, more preferably greater than 3 parts by mass, further preferably greater than 5 parts by mass. Moreover, the content is preferably less than 20 parts by mass, more preferably less than 15 parts by mass, further preferably less than 10 parts by mass. Besides, the content of oil shall also include an amount of oil contained as an extending oil in a rubber component or oil contained in another component such as sulfur.

### <<Liquid Polymer>>

A liquid polymer is a polymer in a liquid state at normal temperature (25° C.), examples of which include, for example, a liquid diene-based polymer, and the like. Examples of the liquid diene-based polymer include a liquid styrene-butadiene copolymer (liquid SBR), a liquid butadiene polymer (liquid BR), a liquid isoprene polymer (liquid IR), a liquid styrene-isoprene copolymer (liquid SIR), and the like. A number average molecular weight (Mn) of the liquid diene-based polymer, which is measured with a gel permeation chromatography (GPC) and calculated in terms of polystyrene, is preferably greater than 1000, more preferably greater than 3000. On the other hand, the Mn is preferably less than 100000, more preferably less than 15000. A Mn of the liquid polymer is a value measured with a gel permeation chromatography (GPC) and calculated in terms of polystyrene. As a liquid diene-based polymer, for example, products from Sartomer, Kuraray Co., Ltd., etc. can be used. The liquid polymer may be used alone, or two or more thereof may be used in combination.

### (Resin Component)

The rubber composition relating to the present embodiment may comprise a resin component in combination. The resin component that can be used in the present embodiment is not particularly limited, and any resin commonly used in the tire industry can be used, examples of which include, for example, a C9-based resin, a C5-based resin, a C5/C9-based resin, a dicyclopentadiene-based resin, an aromatic vinyl-based resin, a coumarone-based resin, an indene-based resin, a terpene-based resin, a rosin-based resin, a phenol-based resin, and the like. These resin components may be used alone, or two or more thereof may be used in combination. Also, each resin component may be used alone, or two or more thereof may be used in combination, respectively.

### <<C9-Based Resin>>

A “C9-based resin” refers to a resin obtained by polymerizing C9 fractions, and may be a polymer obtained by polymerizing a C9 fraction alone or a copolymer obtained by copolymerizing a C9 fraction with other components. For example, a resin obtained by copolymerizing dicyclopentadiene (DCPD) with a C9 fraction is referred to as a DCPD/C9 resin. Moreover, the C9-based resin may be one obtained by hydrogenating or modifying them. Examples of the C9 fraction include, for example, a petroleum fraction having 8 to 10 carbon atoms such as vinyltoluene, alkylstyrene, coumarone, indene, methylindene, dicyclopentadiene, and the like. As the C9-based resin, for example, those commercially available from BASF, Zeon Corporation, ENEOS Corporation, etc. can be used.

### <<C5-Based Resin>>

A “C5-based resin” refers to a resin obtained by polymerizing C5 fractions and may be one obtained by hydrogenating or modifying them. Examples of C5 fractions other than dicyclopentadiene include, for example, a petroleum fraction having 4 to 5 carbon atoms, such as cyclopentadiene, isoprene, piperylene, 2-methyl-1-butene, 2-methyl-2-butene, 1-pentene, and the like. As the C5-based resin, for example, those commercially available from STRUKTOL, Zeon Corporation, ENEOS Corporation, etc. can be used.

### <<C5/C9-Based Resin>>

A “C5/C9-based resin” refers to a resin obtained by copolymerizing the C5 fraction and the C9 fraction and may be one obtained by hydrogenating or modifying them. As the C5/C9-based petroleum resin, for example, those commercially available from Tosoh Corporation, Zibo Luhua Hongjin New Material Group Co., Ltd, etc. can be appropriately used.

### <<Dicyclopentadiene-Based Resin>>

A “dicyclopentadiene-based resin” refers to a resin comprising cyclopentadiene (CPD) and/or dicyclopentadiene (DCPD) as a monomer component having the largest content and may be one obtained by hydrogenating or modifying them. As the dicyclopentadiene-based resin, for example, a polymer obtained by polymerizing only dicyclopentadiene as a monomer, a copolymer obtained by copolymerizing dicyclopentadiene with the C9 fraction (DCPD/C9 resin), and the like are preferable. As the dicyclopentadiene-based resin, for example, those commercially available from Exxon Mobil Corporation, ENEOS Corporation, Zeon Corporation, Maruzen Petrochemical Co., Ltd., etc. can be used.

### <<Aromatic Vinyl-Based Resin>>

An “aromatic vinyl-based resin” refers to a resin comprising an aromatic vinyl compound such as styrene, α-methylstyrene, vinyltoluene, p-chlorostyrene, and the like as a monomer component having the largest content, and may be one obtained by hydrogenating or modifying them. As the aromatic vinyl-based resin, a homopolymer of α-methylstyrene or styrene or a copolymer of α-methylstyrene and styrene is preferable, and a copolymer of α-methylstyrene and styrene is more preferable, because it is economical, easy to process, and excellent in heat generation. As the aromatic vinyl-based resin, for example, those commercially available from Kraton Corporation, Eastman Chemical Company, Mitsui Chemicals, Inc., etc. can be used.

### <<Coumarone-Based Resin>>

A “coumarone-based resin” refers to a resin comprising coumarone as a monomer component and may be one obtained by hydrogenating or modifying it. As the coumarone-based resin, a coumarone resin that is a polymer comprising only coumarone as a monomer component, a coumarone-indene resin that is a copolymer comprising coumarone and indene as monomer components, a coumarone-indene-styrene resin that is a copolymer comprising coumarone, indene, and styrene as monomer components, and the like are preferable. As the coumarone-based resin, for example, those commercially available from Rutgers Chemicals, Nitto Chemical Co., Ltd., Mitsui Chemicals, Inc., etc. can be used.

### Indene-Based Resin>>

An “indene-based resin” refers to a resin comprising indene as a monomer component and may be one obtained by hydrogenating or modifying it. As the indene-based resin, for example, a coumarone-indene resin that is a copolymer comprising coumarone and indene as monomer components, a coumarone-indene-styrene resin that is a copolymer comprising coumarone, indene, and styrene as monomer components, and the like are preferable. As the indene-based resin, for example, those commercially available from Rutgers Chemicals, Nitto Chemical Co., Ltd., Mitsui Chemicals, Inc., etc. can be used.

### <<Terpene-Based Resin>>

A “terpene-based resin” refers to a resin comprising a terpene compound such as α-pinene, β-pinene, limonene, dipentene, and the like as a monomer component, and may be one obtained by hydrogenating or modifying them. As the terpene-based resin, for example, a polyterpene resin that is a polymer comprising only one or more of the terpene compounds as monomer components, an aromatic-modified terpene resin that is a copolymer comprising the terpene compound and an aromatic compound as monomer components, a terpene phenolic resin that is a copolymer comprising the terpene compound and a phenol compound as monomer components, and the like are preferable. Examples of the aromatic compound used as a monomer component for the aromatic-modified terpene resin include, for example, styrene, α-methylstyrene, vinyltoluene, divinyltoluene, and the like. Examples of the phenol compound used as a monomer component for the terpene phenolic resin include, for example, phenol, bisphenol A, cresol, xylenol, and the like. As the terpene-based resin, for example, those commercially available from Yasuhara Chemical Co., Ltd., Arakawa Chemical Industries, Ltd., Nippon Terpene Chemicals, Inc., etc. can be used.

### <<Rosin-Based Resin>>

A “rosin-based resin” refers to a resin comprising a rosin acid compound such as abietic acid, neoabietic acid, palustric acid, isopimaric acid, and the like, and may be one obtained by hydrogenating or modifying them. Example of the rosin-based resin include, but not particularly limited to, for example, a natural resin rosin and a rosin-modified resin obtained by modifying the natural resin rosin by hydrogenation, disproportionation, dimerization, esterification, etc., and the like. As the rosin-based resin, for example, those commercially available from Harima Chemicals Group, Inc., Arakawa Chemical Industries, Ltd., IREC Co., Ltd., etc. can be used.

### <<Phenol-Based Resin>>

A “phenol-based resin” refers to a resin comprising a phenolic compound such as phenol, cresol, and the like as a monomer component, and may be one obtained by hydrogenating or modifying them. Examples of the phenol-based resin include, but not particularly limited to, a phenol formaldehyde resin, an alkylphenol formaldehyde resin, an alkylphenol acetylene resin, an oil-modified phenol formaldehyde resin, a terpene phenolic resin, and the like. As the phenol-based resin, for example, those commercially available from Sumitomo Bakelite Co., Ltd., DIC Corporation, ASAHI YUKIZAI CORPORATION, etc. can be used.

A content of a resin component when compounded based on 100 parts by mass of the rubber component is preferably greater than 2 parts by mass, more preferably greater than 3 parts by mass, further preferably greater than 4 parts by mass. On the other hand, the content is preferably less than 20 parts by mass, more preferably less than 15 parts by mass, further preferably less than 10 parts by mass.

### <<Ester-Based Plasticizing Agent>>

Examples of the ester-based plasticizing agent include, for example, dibutyl adipate (DBA), diisobutyl adipate (DIBA), dioctyl adipate (DOA), di(2-ethylhexyl) azelate (DOZ), dibutyl sebacate (DBS), diisononyl adipate (DINA), diethyl phthalate (DEP), dioctyl phthalate (DOP), diundecyl phthalate (DUP), dibutyl phthalate (DBP), dioctyl sebacate (DOS), tributyl phosphate (TBP), trioctyl phosphate (TOP), triethyl phosphate (TEP), trimethyl phosphate (TMP), thymidine triphosphate (TTP), tricresyl phosphate (TCP), trixylenyl phosphate (TXP), and the like. These ester-based plasticizing agents may be used alone, or two or more thereof may be used in combination.

### (Antioxidant)

Examples of the antioxidant include, but not particularly limited to, a naphthylamine-based antioxidant such as phenyl-α-naphthylamine and the like; a diphenylamine-based antioxidant such as octylated diphenylamine, 4,4′-bis(α,α′-dimethylbenzyl)diphenylamine, and the like; a p-phenylenediamine-based antioxidant such as N-isopropyl-N′-phenyl-p-phenylenediamine, N-(1,3-dimethylbutyl)-N′-phenyl-p-phenylenediamine (6PPD), N,N′-bis(1,4-dimethylpentyl)-p-phenylenediamine (77PD), N,N′-diphenyl-p-phenylenediamine (DPPD), N,N′-ditolyl-p-phenylenediamine (DTPD), N-isopropyl-N′-phenyl-p-phenylenediamine (IPPD), N,N′-di-2-naphthyl-p-phenylenediamine (DNPD), and the like; a quinoline-based antioxidant such as a polymer of 2,2,4-trimethyl-1, 2-dihydroquinoline, and the like; a monophenol-based antioxidant such as 2,6-di-t-butyl-4-methylphenol, styrenated phenol, and the like; bisphenol-based, trisphenol-based, and polyphenol-based antioxidants such as tetrakis-[methylene-3-(3′,5′-di-t-butyl-4′-hydroxyphenyl) propionate]methane and the like; and the like. Among them, the p-phenylenediamine-based antioxidant and the quinoline-based antioxidant are preferable, and N-(1,3-dimethylbutyl)-N′-phenyl-p-phenylenediamine and a polymer of 2,2,4-trimethyl-1,2-dihydroquinoline are more preferable. As the commercially-available product, for example, products from Seiko Chemical Co., Ltd., Sumitomo Chemical Co., Ouchi Shinko Chemical Industry Co., Flexsys, etc. can be used. The antioxidants may be used alone, or two or more thereof may be used in combination.

A content of an antioxidant when compounded based on 100 parts by mass of the rubber component is preferably greater than 0.5 parts by mass, more preferably greater than 0.8 parts by mass, further preferably greater than 1.0 parts by mass. On the other hand, the content is preferably less than 7.0 parts by mass, more preferably less than 5.0 parts by mass, further preferably 3.0 parts by mass or less.

### (Vulcanized Rubber Particle)

The vulcanized rubber particle is a particle made of a vulcanized rubber. Specifically, a rubber powder specified in JIS K6316:2017, and the like can be used. A recycled rubber powder produced from a pulverized product of a waste tire and the like is preferable from the viewpoints of consideration for environment and cost. They may be used alone, or two or more thereof may be used in combination.

The vulcanized rubber particle is not particularly limited and may be a non-modified vulcanized rubber particle or a modified vulcanized rubber particle.

As a commercially available product of a vulcanized rubber, for example, products from Lehigh Technologies, Muraoka Rubber Reclaiming Co., Ltd. etc. can be used.

### (Processing Aid)

Examples of processing aid include, for example, a fatty acid metal salt, a fatty acid amide, an amide ester, a silica surfactant, a mixture of a fatty acid metal salt and an amide ester, a mixture of a fatty acid metal salt and a fatty acid amide, and the like. The processing aid may be used alone, or two or more thereof may be used in combination. As processing aid, for example, those commercially available from Schill+Seilacher GmbH, Performance Additives, etc. can be used.

A content of processing aid when compounded based on 100 parts by mass of the rubber component is preferably greater than 0.5 parts by mass, more preferably greater than 1 part by mass, further preferably greater than 1.5 parts by mass, from the viewpoint of exhibiting an effect of improving processability. Moreover, it is preferably less than 10 parts by mass, more preferably less than 8.0 parts by mass, further preferably less than 5.0 parts by mass, from the viewpoints of abrasion resistance and breaking strength.

### (Wax)

Wax is not particularly limited, and any of those commonly used in the tire industry can be appropriately used, examples of which include, for example, a mineral-based wax, a plant-derived wax, and the like. The mineral-based wax refers to a wax derived from mineral resources such as oil, natural gas, and the like. The plant-derived wax refers to a wax derived from natural resources such as plants. Among them, the mineral-based wax is preferable. Examples of the plant-derived wax include, for example, a rice bran wax, a carnauba wax, a candelilla wax, and the like. Examples of the mineral-based wax include, for example, a paraffin wax, a microcrystalline wax, a specially selected wax thereof, and the like, and the paraffin wax is preferable. Besides, the wax relating to the present embodiment shall not include stearic acid. As wax, for example, those commercially available from Ouchi Shinko Chemical Industry Co., Nippon Seiro Co., Ltd., PARAMELT, etc. can be used. The wax may be used alone, or two or more thereof may be used in combination.

A content of wax when compounded based on 100 parts by mass of the rubber component is preferably greater than 0.3 parts by mass, more preferably greater than 0.7 parts by mass, further preferably greater than 1.0 parts by mass. On the other hand, the content is preferably less than 4.0 parts by mass, more preferably less than 3.0 parts by mass, further preferably less than 2.5 parts by mass.

### (Stearic Acid)

A content of stearic acid when compounded based on 100 parts by mass of the rubber component is preferably greater than 0.5 parts by mass, more preferably greater than 0.7 parts by mass, further preferably 1.0 parts by mass or more, from the viewpoint of processability. On the other hand, the content is preferably less than 10 parts by mass, more preferably less than 5 parts by mass, further preferably less than 3 parts by mass, from the viewpoint of vulcanization rate.

### (Zinc Oxide)

A content of zinc oxide when compounded based on 100 parts by mass of the rubber component is preferably greater than 0.5 parts by mass, more preferably greater than 0.7 parts by mass, further preferably greater than 1 part by mass, from the viewpoint of processability. On the other hand, the content is preferably 10 parts by mass or less, more preferably less than 7 parts by mass, further preferably 5 parts by mass or less, from the viewpoint of abrasion resistance.

### (Vulcanizing Agent)

A vulcanizing agent is not particularly limited, and known vulcanizing agents can be used, examples of which include, for example, organic peroxide, a sulfur-based vulcanizing agent, a resin vulcanizing agent, metallic oxide such as magnesium oxide and the like, etc. Among them, the sulfur-based vulcanizing agent is preferable. As the sulfur-based vulcanizing agent, for example, sulfur donors such as sulfur, morpholine disulfide, and the like, etc. can be used. Among them, it is preferable that sulfur is used. The vulcanizing agent can be used alone, or two or more thereof can be used in combination.

Examples of sulfur include a powdery sulfur, a precipitated sulfur, a colloidal sulfur, a surface-treated sulfur (an oil processing sulfur, a special sulfur treated with a dispersing agent, a masterbatch-type sulfur, and the like), an insoluble sulfur (an oil processing insoluble sulfur and the like), and the like, and any of them can be appropriately used. Among them, the powdery sulfur is preferable. As sulfur, for example, those manufactured and sold by Tsurumi Chemical Industry Co., ltd., Karuizawa Sulfur Co, Ltd., SHIKOKU CHEMICALS CORPORATION, Flexsys, Nippon Kanryu Industry Co., Ltd., Hosoi Chemical Industry Co., Ltd., etc., and the like can be used.

A known organic crosslinking agent can also be used as a vulcanizing agent. Although the organic crosslinking agent is not particularly limited as long as it can form a crosslinking chain other than polysulfide bond, examples of the organic crosslinking agent include, for example, an alkylphenol-sulfur chloride condensate, sodium hexamethylene-1,6-bisthiosulfate dihydrate, 1,6-bis(N,N′-dibenzylthiocarbamoyldithio)hexane, dicumyl peroxide, and the like, and 1,6-bis(N,N′-dibenzylthiocarbamoyldithio)hexane is preferable. As these organic crosslinking agents, those commercially available from Taoka Chemical Co., Ltd., LANXESS, Flexsys, etc. can be used.

A content of a vulcanizing agent when compounded based on 100 parts by mass of the rubber component is preferably greater than 0.4 parts by mass, more preferably greater than 0.5 parts by mass, further preferably greater than 1.0 parts by mass, further preferably greater than 1.5 parts by mass. On the other hand, the content is preferably less than 6.0 parts by mass, more preferably 5.0 parts by mass or less, further preferably less than 4.0 parts by mass. When the content of the vulcanizing agent is within the above-described ranges, an appropriate reinforcing effect tends to be obtained. Besides, in a case where the vulcanizing agent includes a component other than sulfur like an oil-processing sulfur and the like, the content of the vulcanizing agent means a content of a sulfur component itself.

### (Vulcanization Accelerator)

A vulcanization accelerator is not particularly limited, and known vulcanization accelerators can be used, examples of which include, for example, sulfenamide-based, thiazole-based, thiuram-based, thiourea-based, guanidine-based, dithiocarbamic acid-based, aldehyde-amine-based or aldehyde-ammonia-based, imidazoline-based, and xanthate-based vulcanization accelerators. Among them, the sulfenamide-based vulcanization accelerator, the thiuram-based vulcanization accelerator, and the guanidine-based vulcanization accelerator are preferable, and the sulfenamide-based vulcanization accelerator is more preferable. As the vulcanization accelerator, for example, those manufactured and sold by Ouchi Shinko Chemical Industry Co., Ltd., Sanshin Chemical Industry Co., Ltd., etc., and the like can be used. These vulcanization accelerators may be used alone, or two or more thereof may be used in combination.

Examples of the sulfenamide-based vulcanization accelerator include, for example, N-tert-butyl-2-benzothiazolyl sulfenamide (TBBS), N-cyclohexyl-2-benzothiazolyl sulfenamide (CBS), N,N′-dicyclohexyl-2-benzothiazolyl sulfenamide (DZ), and the like. Examples of the thiuram-based vulcanization accelerator include, for example, tetramethylthiuram monosulfide, tetramethylthiuram disulfide, tetrabenzylthiuram disulfide (TBzTD), and the like. Examples of the guanidine-based vulcanization accelerator include, for example, 1,3-diphenylguanidine (DPG), diorthotrilguanidine, orthotrilbiguanidine, and the like.

A content of a vulcanization accelerator based on 100 parts by mass of the rubber component is preferably greater than 0.3 parts by mass, more preferably greater than 0.4 parts by mass, further preferably greater than 0.5 part by mass. On the other hand, the content is preferably less than 4.0 parts by mass, more preferably less than 3.0 parts by mass, further preferably less than 2.0 parts by mass. When the content of the vulcanization accelerator is within the above-described ranges, breaking strength and elongation tend to be able to be secured.

### <Rubber Composition for Inner Liner>

Each component of the rubber composition for inner liner will be described.

### (Rubber Component)

An explanation of a rubber component is not only as described below but also as described in the explanation of the rubber composition for insulation. A rubber composition for inner liner comprises a rubber component comprising a butyl-based rubber. In this case, the rubber component can comprise a rubber component other than butyl-based rubbers. As such a rubber component other than butyl-based rubbers, a rubber component described in the explanation of the rubber composition for insulation can be used. Moreover, the rubber component may be one consisting of a butyl-based rubber. An explanation of a butyl-based rubber is as follows.

### <<Butyl-Based Rubber>>

The butyl-based rubbers are preferably a polymer having an isobutylene unit and an isoprene unit as repeating units and a derivative thereof, and examples of such butyl-based rubbers include a butyl rubber (IIR); a halogenated butyl rubber such as a brominated butyl rubber (Br-IIR), chlorinated butyl rubber (CI-IIR), and the like; and the like. Among them, a halogenated butyl rubber is preferable and a brominated butyl rubber and a chlorinated butyl rubber are more preferable, from the viewpoint that sheet processability and air barrier property can be improved with good balance. They may be used alone, or two or more thereof may be used in combination.

As the butyl-based rubbers, in addition to a usual butyl-based rubber (a butyl-based rubber other than recycled butyl-based rubbers), a recycled butyl-based rubber can be used in combination. Since a content rate of a non-halogenated butyl rubber (regular butyl rubber) in a recycled butyl-based rubber is usually high, a good air barrier property and a good vulcanization rate can be secured by using the recycled butyl rubber in combination with a halogenated butyl rubber. The recycled butyl-based rubbers may be used alone, or two or more thereof may be used in combination.

The rubber component may comprise other rubber components other than butyl-based rubbers. Examples of such other rubber components include, for example, diene-based rubbers such as an isoprene-based rubber (IR-based rubber) a butadiene rubber (BR), a styrene-butadiene rubber (SBR), a styrene-isoprene-butadiene rubber (SIBR), a chloroprene rubber (CR), an acrylonitrile-butadiene rubber (NBR), and the like. The explanation made for the rubber composition for insulation can similarly apply to these other rubber components. These other rubber components may be used alone, or two or more thereof may be used in combination.

A content of a butyl-based rubber in 100% by mass of the rubber component is preferably greater than 70% by mass, more preferably greater than 75% by mass, further preferably 80% by mass or more, particularly preferably 90% or more, from the viewpoint of a sufficient air barrier property.

### (Filler)

A filler can comprise a carbon black. Moreover, the filler can comprise a recovered carbon black (rCB) or silica. In a case where the filler comprises silica, the filler further can comprise a silane coupling agent. The filler can further comprise another filler other than carbon black and silica. The filler preferably comprises carbon black and a recovered carbon black. An explanation of each component capable of constituting the filler is as described in the section of the rubber composition for insulation.

### <<Content of Carbon Black>>

A total content of carbon black comprising a recovered carbon black when compounded based on 100 parts by mass of the rubber component is, for example, greater than 20 parts by mass, preferably greater than 40 parts by mass, more preferably 50 parts by mass or more, further preferably 60 parts by mass or more. On the other hand, the total content is preferably less than 150 parts by mass, more preferably less than 110 parts by mass, further preferably less than 80 parts by mass. When the content of carbon black is within the above-described ranges, a sufficient reinforcing property and a good dispersion in a rubber are obtained, and thus a sufficient rubber strength and a sufficient crack growth resistance tend to be obtained.

In a case where the filler comprises a recovered carbon black, a content rate of the recovered carbon black in the total content of carbon black is, for example, greater than 10% by mass, preferably greater than 20% by mass, more preferably greater than 30% by mass, further preferably 40% by mass or more, from the viewpoint of reinforcing property.

The explanation made for the rubber composition for insulation can similarly apply to these other carbon black (including the recovered carbon black).

### (Other Compounding Agents)

The explanation made for the rubber composition for insulation can similarly apply to descriptions other than the above-described descriptions.

### <Other Rubber Members Constituting Tire>

In the present specification, the tire can comprise other rubber members other than the above-described rubber members. Such other rubber members are not particularly limited, and a variety of rubber members commonly used for a tire can be used.

In the present specification, various materials each having a carbon atom (for example, a rubber, oil, a resin component, a vulcanization accelerator, an antioxidant, a surfactant, and the like) may be derived from carbon dioxide in the atmosphere. These various materials which are compounding substances can be obtained by converting carbon dioxide directly, or converting methane obtained via a process of methanation by which methane is synthesized from carbon dioxide.

### <Application>

In the present specification, the tire can be appropriately used as a pneumatic tire, although the tire may be a pneumatic tire or a non-pneumatic tire. Moreover, in the present specification, the tire can be used for various applications, such as a tire for a passenger car, a heavy-duty tire for a truck/bus and the like, a motorcycle tire, a high-performance tire, and the like.

### <Production Method>

The tire relating to the present embodiment can be produced by a known method.

### (Production of Rubber Composition)

Each of the above-described rubber compositions can be produced by a known method. For example, they can be produced by kneading the respective above-described components with a rubber kneading apparatus such as an open roll, a sealed type kneader (a Banbury mixer, a kneader, etc.), and the like. A kneading step includes, for example, a base kneading step of kneading compounding agents and additives other than a vulcanizing agent and a vulcanization accelerator, and a final kneading (F-kneading) step of adding the vulcanizing agent and the vulcanization accelerator to the kneaded product obtained in the base kneading step and kneading them. Additionally, the base kneading step can also be divided into multiple steps as necessary. Examples of a kneading condition include, but not particularly limited to, for example, a method of kneading at a discharge temperature of 150° C. to 170° C. for 3 to 10 minutes in the base kneading step and kneading at 50° C. to 110° C. for 1 to 5 minutes in the final kneading step.

### (Production of Tire)

Each rubber composition obtained as described above is extruded into a desired shape of each of tire members at an unvulcanized stage, respectively, whereby an unvulcanized insulation and an unvulcanized inner liner can be produced. The insulation and inner liner thus obtained are molded together with other tire members on a tire forming machine by a usual method, whereby an unvulcanized tire can be produced for the tire relating to the present embodiment. The tire can be obtained by heating and pressurizing (vulcanizing) this unvulcanized tire in a vulcanizing machine. Examples of a vulcanization condition include, but not particularly limited to, for example, a method of vulcanizing at 150 to 200° C. for 5 to 30 minutes.

### EXAMPLES

Hereinafter, examples considered to be preferable in implementing the present invention (Examples) will be described, though the scope of the present invention is not limited to only these Examples. Results, which are calculated based on evaluation methods described below considering a rubber composition and a tire obtained in accordance with each Table using various chemicals described below, are shown as a durability index and an air permeation resistance index in the lower part of each Table.

### Materials

Materials used in Examples and Comparative examples are collectively shown below.

Natural rubber: SVR-L

SBR: SBR1502 (manufactured by JSR Corporation, styrene content: 23.5% by mass, vinyl content: 18% by mass, Mw: 500000)

Butyl-based rubber 1: BB2222 (manufactured by Exxon Mobil Corporation, bromobutyl rubber)

Butyl-based rubber 2: Chlorobutyl HT1066 (manufactured by Exxon Mobil Corporation, chlorobutyl rubber)

Carbon black: SHOW BLACK N660 (manufactured by Cabot Japan K.K., N₂SA: 35 m²/g; ash content: 0.5% by mass)

Recovered carbon black (rCB): Carbon black obtained from a pyrolysis process of a tire (ash content: 17% by mass)

Oil 1: Diana process NH-70S (manufactured by Idemitsu Kosan Co., Ltd., aromatic process oil)

Oil 2: PS-32 (manufactured by Idemitsu Kosan Co., Ltd., mineral oil)

Zinc oxide: Zinc oxide No. 2 (manufactured by Mitsui Mining & Smelting Co., Ltd.)

Stearic acid: Bead stearic acid “CAMELLIA” (manufactured by NOF CORPORATION)

Sulfur: HK-200-5 (manufactured by Hosoi Chemical Industry Co., Ltd., powdered sulfur, oil content: 5% by mass)

Vulcanization accelerator 1: Nocceler CZ (manufactured by Ouchi Shinko Chemical Industry Co., Ltd., N-cyclohexyl-2-benzothiazolylsulfenamide)

Vulcanization accelerator 2: Nocceler DM (manufactured by Ouchi Shinko Chemical Industry Co., Ltd., di-2-benzothiazolyl disulfide)

### <Rubber Composition for Insulation>

According to compounding formulations shown in Tables 1 and 2, using a 1.7 L closed Banbury mixer, all chemicals other than sulfur and a vulcanization accelerator are kneaded for 5 minutes at a discharge temperature of 150° C. Next, sulfur and the vulcanization accelerator are added to the obtained kneaded product, and using an open roll, the mixture is kneaded for 4 minutes until the temperature reaches 105° C., to obtain an unvulcanized rubber composition for insulation.

### <Rubber Composition for Inner Liner>

According to the compounding formulations shown in Tables 1 and 2, using a 1.7 L closed Banbury mixer, all chemicals other than sulfur and a vulcanization accelerator are kneaded for 4 minutes until a temperature reaches a discharge temperature at 130° C. to obtain a kneaded product. Next, using a twin-screw open roll, sulfur and the vulcanization accelerator are added to the obtained kneaded product, and the mixture is kneaded for 4 minutes until the temperature reaches 80° C. to obtain an unvulcanized rubber composition for inner liner.

### <Tire>

According to the descriptions in Tables 1 and 2, the unvulcanized rubber composition for insulation and the unvulcanized rubber composition for inner liner are molded into a shape of the insulation (thickness: 0.4 mm) and a shape of the inner liner, respectively, and further attached together with other members to prepare an unvulcanized tire, and the unvulcanized tire is press-vulcanized under a condition at 170° C. for 12 minutes, thereby producing each test tire (size: 195/65R15).

### <Evaluation>

Results of evaluations of respective test tires by evaluation methods described below are described in the corresponding columns in each of the Tables.

### <70° C. tan δ>

70° C. tan δ is measured, using a dynamic viscoelasticity measuring device with a temperature at 70° C., a frequency of 10 Hz, an initial strain of 10%, a dynamic strain of ±1%, and in an extension mode. A sample is cut out from a tire so that a complex of an insulation and an inner liner has a length of 20 mm, a width of 4 mm, and a thickness of 1 mm. A length direction of the sample is made to match the tire circumferential direction and a thickness direction of the sample is made to match the tire radial direction. In collecting the sample, the sample is cut out so that a thickness of the complex including the entire thickness of the insulation becomes 1 mm by appropriately adjusting the thickness of the inner liner.

### <Air Permeation Coefficient>

An air permeation coefficient at 20° C., in cm³·cm/(cm²·s·cmHg), is calculated from a result of measurement of an inner liner according to Annex 2 of JIS K 7126-1 (a gas permeability testing method by a gas chromatography method) using a gas permeability-measuring apparatus (GTR-11A/31A manufactured by GTR TEC Corporation). The results show that the smaller the air permeation coefficient is, the smaller the amount of air permeation is, which leads to an excellent air barrier property.

### <Air Permeation Resistance>

Each test tire is assembled to a standardized rim 15×6.0 JJ and is filled with air at an internal pressure of 230 kPa. This tire is mounted on a drum-type running tester and a standardized load is applied to the tire. This tire is made to run 30000 km on the drum under a condition of a speed at 80 km/h, and air pressure is measured. An air permeation resistance index is indicated by an index with air pressure of the reference Comparative example (Comparative example 2) after running being as 100. The results show that the larger the numerical value of the index is, the more excellent the air permeation resistance after long-term running is.

### <Tire Durability>

Each test tire is assembled to a standardized rim 15×6.0 JJ and is filled with air at an internal pressure of 230 kPa. This tire is mounted on a drum-type running tester and a standardized load is applied to the tire. This tire is made to run on the drum under a condition of a speed at 80 km/h, and a running distance until an inner liner or an insulation is broken is measured. Results are indicated by indexes with a running distance of the reference Comparative example (Comparative example 2) being as 100. The larger the numerical value of the index is, the better the durability is.

A sum of an air permeation resistance index and a tire durability index is defined as an overall performance index.

TABLE 1

| Example | | | | | | |
|---|---|---|---|---|---|---|
| 1 | 2 | 3 | 4 | 5 | 6 | 7 |

Compounding for insulation (parts by mass)

| | | | | | | | |
|---|---|---|---|---|---|---|---|
| Natural rubber | 70 | 70 | 70 | 70 | 70 | 70 | 70 |
| SBR | 30 | 30 | 30 | 30 | 30 | 30 | 30 |
| Carbon black | 30 | — | — | 30 | 30 | — | 30 |
| Recovered carbon black | 30 | 60 | 60 | 30 | 30 | 60 | 30 |
| Oil 1 | 10 | 10 | 10 | 10 | 10 | 10 | 10 |
| Zinc oxide | 5.0 | 5.0 | 5.0 | 5.0 | 5.0 | 5.0 | 5.0 |
| Stearic acid | 1.0 | 1.0 | 1.0 | 1.0 | 1.0 | 1.0 | 1.0 |
| Sulfur | 2.0 | 2.0 | 2.0 | 2.0 | 2.0 | 2.0 | 2.0 |
| Vulcanization accelerator 1 | 1.0 | 1.0 | 1.0 | 1.0 | 1.0 | 1.0 | 1.0 |
| Vulcanization accelerator 2 | 0.5 | 0.5 | 0.5 | 0.5 | 0.5 | 0.5 | 0.5 |

Compounding for inner liner (parts by mass)

| | | | | | | | |
|---|---|---|---|---|---|---|---|
| Butyl-based rubber 1 | 100 | 100 | 100 | 100 | 100 | 100 | 100 |
| Butyl-based rubber 2 | — | — | — | — | — | — | — |
| Carbon black | 50 | 50 | 50 | 50 | 60 | 60 | 25 |
| Recovered carbon black | — | — | — | — | — | — | 25 |
| Oil 2 | 5.0 | 5.0 | 5.0 | 10.0 | 10.0 | 10.0 | 5.0 |
| Zinc oxide | 1.0 | 1.0 | 1.0 | 1.0 | 1.0 | 1.0 | 1.0 |
| Stearic acid | 1.0 | 1.0 | 1.0 | 1.0 | 1.0 | 1.0 | 1.0 |
| Sulfur | 1.0 | 1.0 | 1.0 | 1.0 | 1.0 | 1.0 | 1.0 |
| Vulcanization accelerator 2 | 1.0 | 1.0 | 1.0 | 1.0 | 1.0 | 1.0 | 1.0 |
| 70° C. tan δ | 0.22 | 0.21 | 0.21 | 0.20 | 0.21 | 0.20 | 0.20 |
| Thickness of inner liner (mm) | 1.4 | 1.4 | 1.1 | 1.1 | 1.1 | 1.1 | 1.4 |
| Air permeation coefficient | 17.0 | 17.0 | 17.0 | 17.0 | 14.0 | 14.0 | 17.0 |
| (×10⁻¹¹ cm³ · cm/(cm² · s · cmHg)) | | | | | | | |
| Air permeation resistance index | 115 | 123 | 123 | 123 | 135 | 142 | 131 |
| Tire durability index | 105 | 126 | 126 | 120 | 115 | 138 | 120 |
| Overall performance index | 220 | 249 | 249 | 243 | 250 | 280 | 251 |

TABLE 2

| Comparative example | | | | |
|---|---|---|---|---|
| 1 | 2 | 3 | 4 | 5 |

Compounding for insulation (parts by mass)

| | | | | | |
|---|---|---|---|---|---|
| Natural rubber | 70 | 70 | 70 | 70 | 70 |
| SBR | 30 | 30 | 30 | 30 | 30 |
| Carbon black | 50 | 30 | 30 | 30 | 50 |
| Recovered carbon black | 10 | 30 | 30 | 30 | 10 |
| Oil 1 | 10 | 10 | 10 | 10 | 10 |
| Zinc oxide | 5.0 | 5.0 | 5.0 | 5.0 | 5.0 |
| Stearic acid | 1.0 | 1.0 | 1.0 | 1.0 | 1.0 |
| Sulfur | 2.0 | 2.0 | 2.0 | 2.0 | 2.0 |
| Vulcanization accelerator 1 | 1.0 | 1.0 | 1.0 | 1.0 | 1.0 |
| Vulcanization accelerator 2 | 0.5 | 0.5 | 0.5 | 0.5 | 0.5 |

Compounding for inner liner (parts by mass)

| | | | | | |
|---|---|---|---|---|---|
| Butyl-based rubber 1 | 100 | 100 | 100 | 100 | — |
| Butyl-based rubber 2 | — | — | — | — | 100 |
| Carbon black | 50 | 50 | 70 | 40 | 70 |
| Recovered carbon black | — | — | — | — | — |
| Oil 2 | 5.0 | 5.0 | 5.0 | 5.0 | 5.0 |
| Zinc oxide | 1.0 | 1.0 | 1.0 | 1.0 | 1.0 |
| Stearic acid | 1.0 | 1.0 | 1.0 | 1.0 | 1.0 |
| Sulfur | 1.0 | 1.0 | 1.0 | 1.0 | 1.0 |
| Vulcanization accelerator 2 | 1.0 | 1.0 | 1.0 | 1.0 | 1.0 |
| 70° C. tan δ | 0.23 | 0.22 | 0.24 | 0.21 | 0.25 |
| Thickness of inner liner (mm) | 1.4 | 1.6 | 1.4 | 1.4 | 1.6 |
| Air permeation coefficient | 17.0 | 17.0 | 17.0 | 19.0 | 20.0 |
| (×10⁻¹¹ cm³ · cm/(cm² · s · cmHg)) | | | | | |
| Air permeation resistance index | 92 | 100 | 92 | 77 | 62 |
| Tire durability index | 95 | 100 | 94 | 100 | 84 |
| Overall performance index | 187 | 200 | 186 | 177 | 146 |

### EMBODIMENTS

Preferred embodiments are described below.

(1) A tire comprising an inner liner and an insulation touching the inner liner on an outer side of the inner liner in a tire radial direction,
wherein the insulation is composed of a rubber composition comprising a recovered carbon black,
wherein an air permeation coefficient of a rubber composition constituting the inner liner is less than 18×10⁻¹¹ cm³·cm/(cm²·s·cmHg),
wherein a thickness of the inner liner on a tire equatorial plane is 1.5 mm or less, preferably 1.4 mm or less, and
wherein a loss tangent at 70° C., 70° C. tan δ, of a complex of the insulation and the inner liner is 0.22 or less, preferably 0.21 or less, more preferably 0.20 or less.

(2) The tire of (1) above, wherein the thickness of the inner liner on the tire equatorial plane is 1.2 mm or less, more preferably 1.1 mm or less.

(3) The tire of (1) or (2) above, wherein the air permeation coefficient of the rubber composition constituting the inner liner is 17×10⁻¹¹ cm³·cm/(cm²·s·cmHg) or less, preferably 16×10⁻¹¹ cm³·cm/(cm²·s·cmHg) or less, more preferably less than 15×10⁻¹¹ cm³·cm/(cm²·s·cmHg), further preferably 14.0×10⁻¹¹ cm³·cm/(cm²·s·cmHg) or less.

(4) The tire of any one of (1) to (3) above, wherein a rubber composition constituting the insulation comprises a rubber component comprising greater than 20% by mass, preferably greater than 30% by mass, more preferably greater than 40% by mass, further preferably 50% by mass or more of an isoprene-based rubber, and the rubber composition constituting the inner liner comprises a rubber component comprising greater than 70% by mass, preferably greater than 75% by mass, more preferably 80% by mass or more, further preferably 90% by mass or more of a butyl-based rubber.

(5) The tire any one of (1) to (4) above, wherein a statistical thickness surface area (STSA), in m²/g, of the recovered carbon black is greater than 37, preferably greater than 40 m²/g, more preferably greater than 45 m²/g and less than 77, and STSA is preferably less than 75 m²/g, more preferably less than 73 m²/g, and wherein an ash content, in % by mass, of the recovered carbon black is greater than 11% by mass, preferably 13% by mass or more, more preferably 15% by mass or more, further preferably 16% by mass or more, further preferably 17% by mass or more, and the ash content is less than 27% by mass, preferably less than 26% by mass, more preferably less than 25% by mass.

### REFERENCE SIGNS LIST

1 Tire
2 Insulation rubber
3 Inner liner rubber
CL Tire equatorial plane
L Thickness of inner liner rubber on tire equatorial plane
R Rim

What is claimed is:

1. A tire comprising an inner liner and an insulation touching the inner liner on an outer side of the inner liner in a tire radial direction,
wherein the insulation is composed of a rubber composition comprising a recovered carbon black,
wherein an air permeation coefficient of a rubber composition constituting the inner liner is less than 18×10⁻¹¹ cm³·cm/(cm²·s·cmHg),
wherein a thickness of the inner liner on a tire equatorial plane is 1.5 mm or less, and
wherein a loss tangent at 70° C., 70° C. tan δ, of a complex of the insulation and the inner liner is 0.22 or less.

2. The tire of claim 1, wherein the thickness of the inner liner on the tire equatorial plane is 1.2 mm or less.

3. The tire of claim 1, wherein the air permeation coefficient of the rubber composition constituting the inner liner is less than 15×10⁻¹¹ cm³·cm/(cm²·s·cmHg).

4. The tire of claim 1, wherein a rubber composition constituting the insulation comprises a rubber component comprising greater than 20% by mass of an isoprene-based rubber, and the rubber composition constituting the inner liner comprises a rubber component comprising greater than 70% by mass of a butyl-based rubber.

5. The tire of claim 1, wherein a statistical thickness surface area (STSA), in m²/g, of the recovered carbon black is greater than 37 and less than 77, and an ash content, in % by mass, of the recovered carbon black is greater than 11 and less than 27.
